(19) United States
(12) Patent Application Publication
(10) Pub. No.: US 2016/0090023 A1
(43) Pub. Date: Mar. 31, 2016

(54) INFORMATION DISPLAY DEVICE AND INFORMATION DISPLAY METHOD

(71) Applicant: TOYOTA JIDOSHA KABUSHIKI KAISHA, Toyota-shi, Aichi-ken (JP)

(72) Inventor: Kazuya ASAOKA, Seto-shi, Aichi-ken (JP)

(73) Assignee: TOYOTA JIDOSHA KABUSHIKI KAISHA, Toyota-shi, Aichi-ken (JP)

(21) Appl. No.: 14/782,708

(22) PCT Filed: Mar. 31, 2014
(86) PCT No.: PCT/IB2014/000448

§ 371 Date: Oct. 6, 2015

(30) Foreign Application Priority Data
Apr. 11, 2013 (JP) 2013-082812

(51) Int. Cl. B60Q 1/06; G01B 11/14; G09G 3/00; B60R 1/00

(52) U.S. Cl. CPC B60Q 1/06; B60R 1/00; G01B 11/14; G09G 3/003; B60R 2300/8033; G09G 2380/10; G09G 2320/08; G09G 2320/062

(57) ABSTRACT

An information display device for displaying information that allows an attention target to be visually recognized includes an image generation unit (1724) that identifies an attention target and generates a shadow image with a position of the target as a base point; and a light driving unit (180) that projects the shadow image when a light illuminates.

### BACKGROUND OF THE INVENTION

1. Field of the Invention

The present invention relates to an information display device and an information display method.

2. Description of Related Art

A technology is known that projects visually recognizable information on a road surface to allow the driver to visually recognize predetermined information. This information is, for example, an image that tells a driver which direction to turn at an intersection. Projecting visually recognizable information on a road surface enables the driver to visually recognize the predetermined information without having to largely moving the line of sight.

Another technology is known that reduces the lightness of a part of an illuminated part on a road surface when a beam is emitted from a beam projector, such as a headlight, onto a pedestrian and displays the position of, and the distance to, the pedestrian in that part. This technology aims to attract attention of both a driver and a person (for example, see Japanese Patent Application Publication No. 2009-149152 (JP 2009-149152 A).

When the position of, and the distance to, a pedestrian are displayed using an geometric image such as an arrow or dots, the driver can determine that there is something ahead of the geometric image. However, the driver cannot determine what is actually present ahead of the geometric image unless the driver visually recognizes the position ahead of the geometric image.

For example, when there is a pedestrian on a road, a driver can determine that there is a pedestrian on the road by first viewing an image displayed on a road surface and then viewing an object in the position ahead of the position indicated by the image. In other words, the driver cannot determine that there is a pedestrian on the road simply by viewing an image displayed on the road surface. This means that the driver must change the line of sight from an image, displayed on the road surface, to an object in the position ahead of the position indicated by the image. That is, by simply viewing only an image displayed on a road surface, it is difficult for a driver to intuitively know what is on the road and, therefore, difficult to immediately determine the attention target. In addition, when there are two or more pedestrians or the driver is not familiar with an attention-attracting geometric image, the driver maybe confused.

### SUMMARY OF THE INVENTION

It is an object of the present invention to provide an information display device and an information display method for allowing a driver to intuitively determine an attention target.

An information display device in a first aspect of the present invention is an information display device for displaying information that allows an attention target to be visually recognized. The information display device includes an image generation unit that identifies the attention target and generates a shadow image with a position of the target as a base point; and a light driving unit that projects the shadow image, generated by the image generation unit, when a light illuminates.

An information display method in a second aspect of the present invention is an information display method for use on an information display device for displaying information that allows an attention target to be visually recognized. The information display method includes identifying the attention target; generating a shadow image with a position of the target as a base point; and projecting the shadow image when a light illuminates.

According to the first and second aspects of the present invention described above, a driver can intuitively determine an attention target.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing one exemplary embodiment of a vehicle in which an information display device of the present invention is mounted;

FIG. 2 is a diagram showing one exemplary embodiment of the information display device;

FIG. 3 is a functional block diagram showing one exemplary embodiment of the information display device;

FIG. 4 is a diagram showing one exemplary embodiment of the operation of the information display device;

FIG. 5 is a diagram showing one exemplary embodiment of the operation of the information display device; and

FIG. 6 is a flowchart showing one exemplary embodiment of the operation of the information display device.

### DETAILED DESCRIPTION OF EMBODIMENTS

Next, the mode for carrying out the present invention is described based on the exemplary embodiments given below with reference to the drawings. It should be noted that the exemplary embodiments described below are only exemplary and that the mode in which the present invention is applied is not limited to the exemplary embodiments below. In all of the drawings for describing the exemplary embodiments, the same reference numeral is given to components having the same function and repetitive description will not be given.

### Exemplary Embodiment

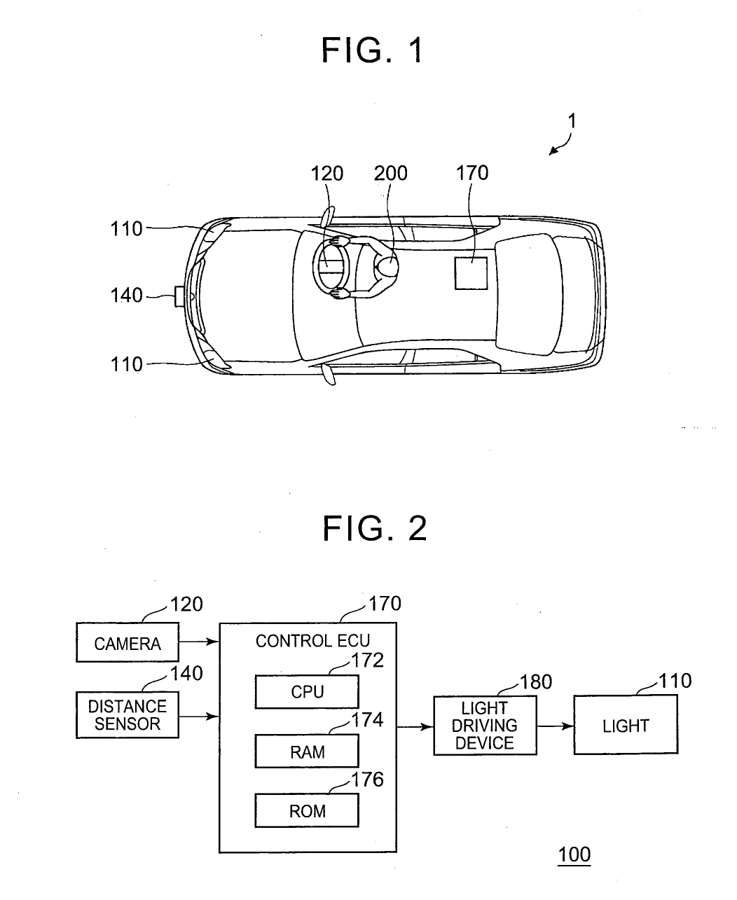

A vehicle in which an information display device is mounted and the information display device are described below with reference to FIG. 1 and FIG. 2.

An information display device 100 shown in FIG. 2 projects the shadow image of an attention target when the headlight illuminates the attention target. In one exemplary embodiment of the information display device 100, a pedestrian is used as the attention target. It should be noted that the attention target is not limited to a pedestrian but is applicable to a person or an object other than a pedestrian.

FIG. 1 shows a light 110, a camera 120, a distance sensor 140, a control electronic control unit (ECU) 170, and a driver 200.

The information display device 100 projects the shadow image of a pedestrian (hereinafter called a “pedestrian image”) when the headlight illuminates the pedestrian. Preferably, the information display device 100 projects a pedestrian image between the headlight and the pedestrian. This is because the pedestrian image must be distinguished from a shadow that is cast behind the pedestrian by the light illumination. Preferably, the pedestrian image indicates the position of and the distance to, a pedestrian illuminated by the headlight. The pedestrian image, which indicates the position of, and the distance to, a pedestrian illuminated by the headlight, allows the driver to intuitively know the position of, and the distance to, the pedestrian.

Preferably, the information display device 100 is mounted on a moving object such as a vehicle. In one exemplary embodiment, the information display device 100 is mounted on a vehicle 1.

In one exemplary embodiment of the information display device of the present invention, the information display device 100 includes the light 110, camera 120, distance sensor 140, control electronic control unit 170, and light driving device 180.

The light 110 emits a beam in the direction of a road surface. Preferably, the light 110 is a headlight. The light 110 is configured by a LED array or a projector capable of covering the projection range from a low beam position to a high beam position. The light 110 is driven by the light driving device 180. The light 110 includes an image forming illumination device (not shown) that emits a beam in the direction of a road surface and a beam distribution control device (not shown) that controls the distribution of a beam emitted from the image forming illumination device.

The beam emitted from the image forming illumination device is not limited to a visible light; instead, the beam may be an infrared light beam or an ultraviolet light beam. When the beam is an infrared light beam or an ultraviolet light beam, a device such as a head mount display is preferably added so that the driver 200 can recognize the beam. This added device enables the driver 200 to recognize an infrared light beam and an ultraviolet light beam.

Preferably the beam distribution control device is configured by a reflection spatial light modulation element or a transmission spatial light modulation element. The reflection spatial lightmodulation element, such as a digital micromirror device (DMD), controls beam distribution by reflecting a beam emitted from the image forming illumination device. The transmission spatial lightmodulation element, such as a liquid crystal display element, controls beam distribution by transmitting a beam emitted from the image forming illumination device.

The beam distribution control device reduces or shields a beam emitted from the image forming illumination device to reduce the lightness of a part of the beam-illuminated part. By reducing the lightness of a part of the beam-illuminated part, a lightness-reduced part is displayed on the road surface.

A predetermined lightness-reduced part is displayed on the road surface by first driving beam distribution control device so that a predetermined lightness-reduced part is displayed and, then, emitting a beam from the image forming illumination device. A predetermined lightness-reduced part may also be displayed on the road surface by first emitting a beam from the image forming illumination device and, then, driving the beam distribution control device so that a predetermined lightness-reduced part is displayed.

The camera 120 is an infrared camera (near infrared camera or far infrared camera). The camera 120 shoots the area in front of the vehicle 1 and outputs a thermal image, obtained by the shooting, as thermal image data. The camera 120 is connected to the control ECU 170. The camera 120 may be a visible camera.

The control ECU 170 controls the projection of a pedestrian image while the light 110 illuminates a pedestrian. The control ECU 170 includes a CPU 172, a RAM 174, and a ROM 176. The CPU 172 controls the projection of a pedestrian image while the light 110 illuminates a pedestrian. The RAM 174 stores data temporarily. The ROM 176 stores the programs for executing the processing routine of control processing for projecting a pedestrian image and the programs of processing routines for various types of processing.

The control ECU 170 may include a plurality of CPUs. The control ECU 170 may include one or more microcomputers. Microcomputers and CPUs may be mixed in the control ECU 170.

### <Function of Control ECU 170>

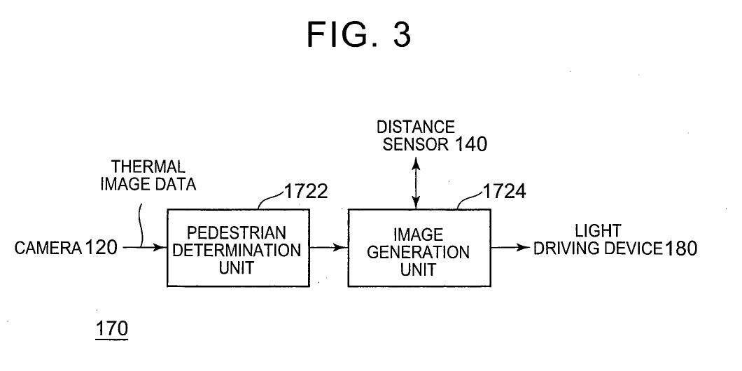

FIG. 3 a functional block diagram showing one exemplary embodiment of the functions of the control ECU 170.

The functions indicated by the functional block diagram shown in FIG. 3 are executed primarily by the CPU 172 included in the control ECU 170. That is, the CPU 172 function as a pedestrian determination unit 1722 and an image generation unit 1724.

Preferably, the CPU 172 executes the function of the pedestrian determination unit 1722 and the image generation unit 1724 according to the application (firmware) stored in the CPU 172. It is also possible for the CPU 172 to execute the function of the pedestrian determination unit 1722 and the image generation unit 1724 according to the application stored in the ROM 176.

The pedestrian determination unit 1722 receives thermal image data from the camera 120. Based on the thermal image data received from the camera 120, the pedestrian determination unit 1722 performs image processing, such as pattern matching, to detect the feature of a person or an object. The feature of a person or an object is, for example, the temperature and shape thereof. Based on the detected feature of a person or an object, the pedestrian determination unit 1722 determines whether there is a pedestrian ahead of the vehicle 1. If it is determined that a pedestrian is located ahead of the vehicle 1, the pedestrian determination unit 1722 informs the image generation unit 1724 that a pedestrian is detected.

The image generation unit 1724 is connected to the pedestrian determination unit 1722. When a notification indicating that a pedestrian is detected is received from the pedestrian determination unit 1722, the image generation unit 1724 generates an image via which the driver visually recognizes the position of, and the distance to, the pedestrian. When a notification indicating that a pedestrian is detected is received from the pedestrian determination unit 1722, the image generation unit 1724 instructs the distance sensor 140 to detect the distance between the pedestrian and the vehicle 1.

The distance sensor 140 is connected to the control ECU 170. The distance sensor 140 is, for example, a millimeter wave radar. The distance sensor 140 detects the distance between a pedestrian, detected by the pedestrian determination unit 1722, and an information display device. The distance sensor 140 sends data about the distance between the vehicle 1 and a pedestrian to the image generation unit 1724.

The image generation unit 1724 generates an image, which allows the driver 200 to visually recognize the position of, and the distance to, a pedestrian, based on the data about the distance between the vehicle 1 and a pedestrian received from the distance sensor 140.

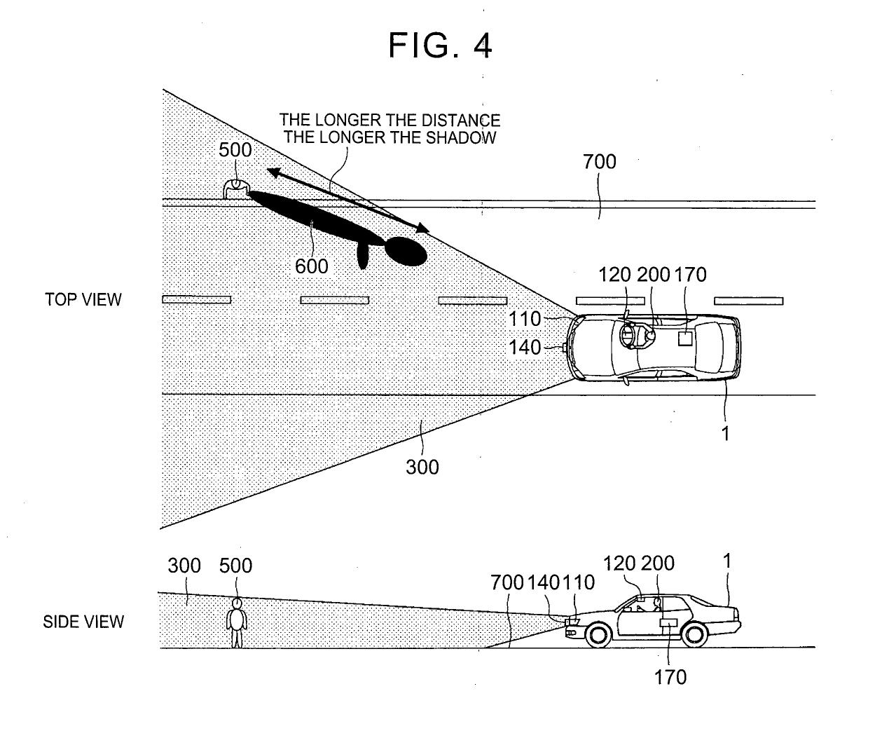

FIG. 4 is a diagram showing one exemplary embodiment of the processing performed by the image generation unit 1724. One exemplary embodiment shown in FIG. 4 indicates an example in which there is a pedestrian 500 ahead of a vehicle and the shadow image of the pedestrian 500 is projected by the information display device 100.

The image generation unit 1724 receives data about the distance between the vehicle 1 and the pedestrian 500 from the distance sensor 140. The image generation unit 1724 calculates the relative position of the pedestrian based on the data about the distance between the vehicle 1 and the pedestrian 500 received from the distance sensor 140.

The image generation unit 1724 generates an image, which allows the driver 200 to visually recognize the position of, and the distance to, the pedestrian 500, based on the calculated relative position of the pedestrian and the distance between the vehicle 1 and the pedestrian 500.

The image generation unit 1724 instructs the light driving device 180 to display a lightness-reduced part on the road surface. Preferably, the image generation unit 1724 instructs the light driving device 180 to display a lightness-reduced part on the road surface between the vehicle 1 and the pedestrian 500.

The image generation unit 1724 generates a pedestrian image that will be projected in the lightness-reduced part displayed on the road surface. The direction to a pedestrian and the distance to the pedestrian are represented by the shadow image of the pedestrian. To represent the direction and the distance, the image generation unit 1724 generates a pedestrian image, which will be projected, as follows. With the pedestrian's feet (or the vicinity of the relative position of the pedestrian) as a base point, the image generation unit 1724 projects a pedestrian image in such a way that the base point coincides with the feet of the pedestrian image based on the relative position of the pedestrian. In addition, the image generation unit 1724 generates the pedestrian image in such a way that the distance between the vehicle 1 and the pedestrian is represented by the length (height) of the pedestrian image. More specifically, the image generation unit 1724 generates the pedestrian image in such a way that, based on the distance between the vehicle 1 and the pedestrian, the longer the distance is, the longer the length of the pedestrian image is. Similarly, the image generation unit 1724 generates the pedestrian image in such a way that, based on the distance between the vehicle 1 and the pedestrian, the shorter the distance is, the shorter the length of the pedestrian image is.

Preferably, the image generation unit 1724 periodically calculates the distance between the pedestrian 500 and the vehicle 1 and the relative position of the pedestrian. Preferably, the image generation unit 1724 updates a pedestrian image 600 based on the distance between the pedestrian 500 and the vehicle 1 and on the relative position of the pedestrian. It is also possible for the image generation unit 1724 to non-periodically calculate the distance between the pedestrian 500 and the vehicle 1 and the relative position of the pedestrian. In this case, too, the image generation unit 1724 preferably updates the pedestrian image 600 based on the distance between the pedestrian 500 and the vehicle 1 and on the relative position of the pedestrian.

The image generation unit 1724 sends the pedestrian image to the light driving device 180.

The light driving device 180 is connected to the light 110 and the control ECU 170. The light driving device 180 drives the light 110. The light driving device 180 drives the beam distribution control device so that a predetermined lightness-reduced part is displayed and causes the image forming illumination device to emit a beam. The light driving device 18a drives (controls) the beam distribution control device so that the lightness-reduced part is displayed between the vehicle 1 and the pedestrian 500 and causes the image forming illumination device to emit a beam. That is, the light driving device 180 controls the light illumination range so that the lightness-reduced part is displayed between the vehicle 1 and the pedestrian 500. Doing so displays the predetermined lightness-reduced part. It is also possible for the light driving device 180 to drive the beam distribution control device so that a predetermined lightness-reduced part is displayed with a beam emitted from the image forming illumination device.

In addition, the light driving device 180 projects the pedestrian image, received from the image generation unit 1724, while driving the light 110. Preferably, the light driving device 180 projects the pedestrian image in the lightness-reduced part displayed on the road surface. That is, the light driving device 180 projects the pedestrian image in the lightness-reduced part displayed between the vehicle 1 and the pedestrian 500. Projecting the pedestrian image in the lightness-reduced part, displayed between the vehicle 1 and the pedestrian 500, allows a driver to distinguish the pedestrian image from the shadow that is cast behind the pedestrian by the light illumination.

The light 110 is connected to the light driving device 180. The light 110 illuminates the road ahead of the vehicle 1, which is traveling on a road surface 700, according to the control performed by the light driving device 180.

In the example shown in FIG. 4, the pedestrian image 600 is represented by a near-zero-lightness black pattern in an illumination range 300 of the light 110.

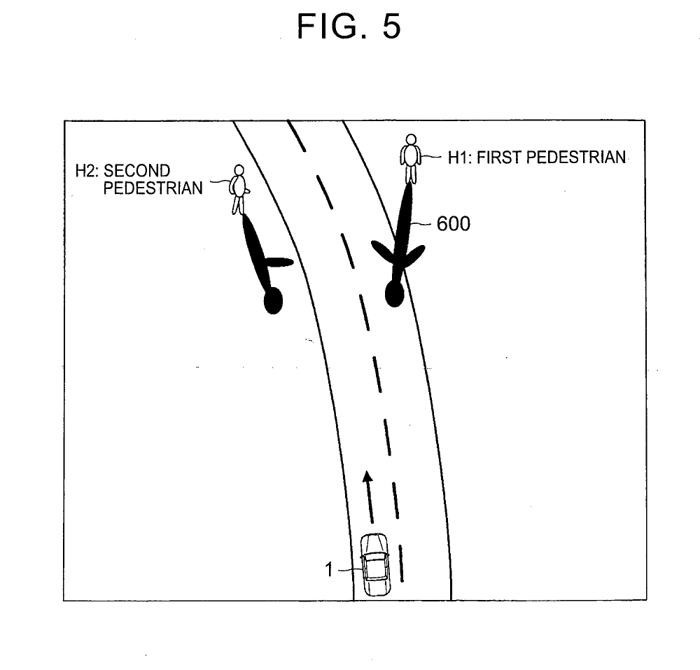

FIG. 5 is a diagram showing one exemplary embodiment of a pedestrian image when there is a plurality of pedestrians ahead of the vehicle 1.

In the example shown in FIG. 5, there is a first pedestrian H1 and a second pedestrian H2 ahead of the vehicle 1 when the vehicle 1 draws near a point where the road curves to the left.

The pedestrian determination unit 1722 performs image processing, such as pattern matching, based on the thermal image data received from the camera 120, to detect the first pedestrian H1 and the second pedestrian H2.

The image generation unit 1724 calculates the relative position of each pedestrian based on the data about the distance between the vehicle 1 and each pedestrian received from the distance sensor 140. That is, the image generation unit 1724 calculates the relative position of the first pedestrian H1 based on the data about the distance between the vehicle 1 and the first pedestrian H1 received from the distance sensor 140. Similarly, the image generation unit 1724 calculates the relative position of the second pedestrian H2 based on the data about the distance between the vehicle 1 and the second pedestrian H2 received from the distance sensor 140.

The image generation unit 1724 generates an image, which allows the driver to visually recognize the position of, and the distance to, the pedestrian, based on the relative position of each pedestrian obtained by the calculation. That is, the image generation unit 1724 generates an image, which allows the driver to visually recognize the position of, and the distance to, the first pedestrian H1, based on the calculated relative position of the first pedestrian H1 and the distance between the vehicle 1 and the first pedestrian H1. Similarly, the image generation unit 1724 generates an image, which allows the driver to visually recognize the position of, and the distance to, the second pedestrian H2, based on the calculated relative position of the second pedestrian H2 and the distance between the vehicle 1 and the second pedestrian H2.

The image generation unit 1724 instructs the light driving device 180 to display a lightness-reduced part on the road surface. Preferably, the image generation unit 1724 instructs the light driving device 180 to display a lightness-reduced part on the road surface between the vehicle 1 and the pedestrian.

The image generation unit 1724 generates a pedestrian image that will be projected in the lightness-reduced part displayed on the road surface. The direction and distance to the pedestrian are represented by the pedestrian image. To represent the direction and the distance, the image generation unit 1724 generates a pedestrian image, which will be projected, as follows. With the vicinity of the pedestrian's feet as a base point, the image generation unit 1724 projects a pedestrian image in such a way that the base point coincides with the feet of the shadow image of the pedestrian based on the relative position of the pedestrian. In addition, the image generation unit 1724 generates the pedestrian image in such a way that the distance between the vehicle 1 and the pedestrian is represented by the length (height) of the shadow image of the pedestrian. More specifically, the image generation unit 1724 generates the pedestrian image in such a way that, based on the distance between the vehicle 1 and the pedestrian, the longer the distance is, the longer the length of the pedestrian image is. Similarly, the image generation unit 1724 generates the pedestrian image in such a way that, based on the distance between the vehicle 1 and the pedestrian, the shorter the distance is, the shorter the length of the pedestrian image is.

The light driving device 180 drives (controls) the beam distribution control device so that a lightness-reduced part is displayed between the vehicle 1 and each pedestrian and causes the image forming illumination device to emit a beam. That is, the light driving device 180 controls the light illumination range so that the lightness-reduced part is displayed between the vehicle 1 and each pedestrian. The lightness-reduced parts may overlap depending upon the positions of the pedestrians.

In the example shown in FIG. 5, the shadow image of each pedestrian is represented by a near-zero-lightness black pattern in the illumination range of the light 110. That is, the shadow image of each pedestrian is projected in the lightness-reduced part (not shown) displayed on the road surface. Projecting the shadow image of each pedestrian in the lightness-reduced part allows a driver to distinguish the shadow image of each pedestrian from the shadow that is cast behind the pedestrian by the light illumination. The distance between the first pedestrian H1 and the vehicle 1 is longer than the distance between the second pedestrian H2 and the vehicle 1. Therefore, the length of, the projected shadow of the first pedestrian H1 is longer than the length of the projected shadow of the second pedestrian 112.

### <Operation of Information Display Device 100>

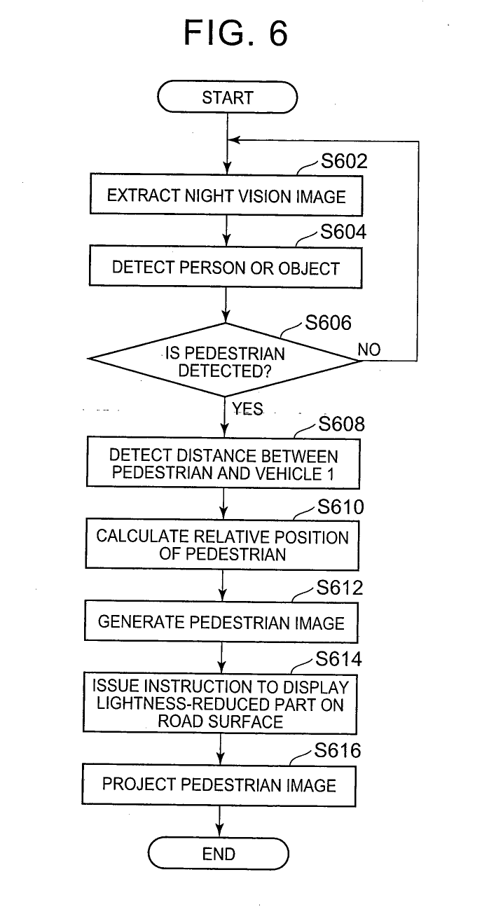

FIG. 6 is a flowchart showing one exemplary embodiment of the operation of the information display device 100. FIG. 6 shows primarily the operation of the control ECU 170.

In step S602, the information display device 100 extracts a night vision image. More specifically, the pedestrian determination unit 1722 extracts a night vision image from thermal image data received from the camera 120.

In step S604, the information display device 100 detects a person or an object. More specifically, the pedestrian determination unit 1722 detects a person or an object from the night vision image extracted in step S602.

In step S606, the information display device 100 determines whether a pedestrian is detected. More specifically, the pedestrian determination unit 1722 determines whether the person, extracted as a result of the extraction of a person or an object from the night vision image, is a pedestrian. If a pedestrian is not detected, the processing returns to step S602.

In step S608, if it is determined in step S606 that a pedestrian is detected, the information display device 100 detects the distance between the pedestrian and the vehicle 1. More specifically, in response to an instruction from the image generation unit 1724, the distance sensor 140 detects the distance between the pedestrian and the vehicle 1.

In step S610, the information display device 100 calculates the relative position of the pedestrian based on the distance between the pedestrian and the vehicle 1. More specifically, the image generation unit 1724 receives the distance between the pedestrian and the vehicle 1 from the distance sensor 140 and calculates the relative position of the pedestrian.

In step S612, the information display device 100 generates a pedestrian image. More specifically, the image generation unit 1724 generates a pedestrian image.

In step S614, the information display device 100 issues an instruction to display a lightness-reduced part on the road surface. More specifically, the image generation unit 1724 instructs the light driving device 180 to display a lightness-reduced part on the road surface.

In step S616, the information display device 100 projects the pedestrian image. More specifically, the image generation unit 1724 sends the pedestrian image, which will be projected, to the light driving device 180. The light driving device 180 projects the pedestrian image received from the image generation unit 1724.

According to one exemplary embodiment of the information display device 100, projecting the shadow of a pedestrian allows a driver to intuitively know the position of, and the distance to, the pedestrian. The information display device 100 projects a pedestrian image so that, with the vicinity of the pedestrian's feet as a base point, the base point coincides with the feet of the pedestrian image. In addition, the information display device 100 generates the pedestrian image in such a way that the distance to the pedestrian is represented by the length (height) of the pedestrian image. This enables the driver to know the pedestrian's position based on the base point and to know the distance to the pedestrian based on the length of the pedestrian image.

Although the present invention has been described with reference to the specific embodiments and modifications, these embodiments and modifications are only examples. It will be obvious to those skilled in the art that various modifications, changes, alternatives, and replacements may be made. Although the device in the embodiments of the present invention have been described according to the functional block diagram for the sake of description, the present invention is not limited to the embodiments described above. The present invention may include various modifications, changes, alternatives, and replacements without departing from the present invention.

1. An information display device for displaying information that allows a pedestrian to be visually recognized, the information display device comprising:
an image generation unit that identifies the pedestrian and generates a shadow image of the pedestrian with a position of the pedestrian as a base point; and
a light driving unit that projects the shadow image of the pedestrian, generated by the image generation unit, when a light illuminates.

2. The information display device according to claim 1, wherein
the light driving unit is configured to control an illumination range of the light so that the shadow image of the pedestrian, generated by the image generation unit, is projected between the pedestrian and the light.

3. The information display device according to claim 1, wherein
the image generation unit is configured to change a length of the shadow image of the pedestrian according to a distance between the information display device and the pedestrian.

4. The information display device according to claim 1, wherein
the image generation unit acquires data about a distance between the information display device and the pedestrian from a distance sensor and, based on the distance between the information display device and the pedestrian, identifies the position of the pedestrian.

5. The information display device according to claim 1, wherein
the light driving unit is configured to control an illumination range of the light so that a beam is emitted in a direction of a road surface and, at the same time, to control a beam distribution of the emitted beam.

6. The information display device according to claim 5, wherein
the light driving unit controls the light in such a way that beam distribution is controlled by reflecting the emitted beam.

7. The information display device according to claim 5, wherein
the light comprises an image forming illumination device that emits the beam in the direction of the road surface; and a beam distribution control device that controls the beam distribution of the beam emitted from the image forming illumination device wherein the light driving unit controls the beam distribution control device in such a way that the beam distribution control device reflects the beam emitted from the image forming illumination device.

8. The information display device according to claim 1, wherein
the light driving unit is configured to drive the light in such a way that a lightness-reduced part is displayed on a road surface with a lightness of a part of an illumination range of the light reduced and, at the same time, to project the shadow image of the pedestrian in the lightness-reduced part.

9. An information display method for use on an information display device for displaying information that allows a pedestrian to be visually recognized, the information display method comprising:
identifying the pedestrian;
generating a shadow image of the pedestrian with a position of the pedestrian as a base point; and
projecting the shadow image of the pedestrian when a light illuminates.

10. The information display method according to claim 9, wherein
when the shadow image of the pedestrian is projected, the generated shadow image of the pedestrian is projected between the pedestrian and the light.

11. The information display method according to claim 9, wherein
when the shadow image of the pedestrian is generated, a length of the shadow image of the pedestrian is changed according to a distance between the information display device and the pedestrian.

12. The information display method according to claim 9, further comprising:
acquiring data about a distance between the information display device and the pedestrian from a distance sensor; and
identifying the position of the pedestrian based on the distance between the information display device and the pedestrian.

13. The information display method according to claim 9, wherein
when the shadow image of the pedestrian is projected, the light is driven in such a way that a lightness-reduced part is displayed on a road surface with a lightness of a part of an illumination range of the light reduced and, at the same time, the shadow image of the pedestrian is projected in the lightness-reduced part.
